(19) United States
(12) Patent Application Publication
(10) Pub. No.: US 2013/0107754 A1
(43) Pub. Date: May 2, 2013

(54) METHOD FOR CONFIGURING A DELAY/DISRUPTION-TOLERANT NETWORK NODE AND CONFIGURABLE NODE OPERABLE IN A DELAY/DISRUPTION-TOLERANT NETWORK

(71) Applicants: Simon Perreault, Quebec (CA); Jean-Philippe Dionne, Quebec (CA); Marc Blanchet, St-Augustin (CA)

(72) Inventors: Simon Perreault, Quebec (CA); Jean-Philippe Dionne, Quebec (CA); Marc Blanchet, St-Augustin (CA)

(73) Assignee: VIAGENIE, Quebec (CA)

(21) Appl. No.: 13/282,016

(22) Filed: Oct. 26, 2011

(51) Int. Cl. H04L 12/28

(52) U.S. Cl. 370/255

(57) ABSTRACT

The present disclosure relates to methods for configuring Delay/disruption-Tolerant Network (DTN) nodes and to configurable nodes operable in Delay/disruption-Tolerant Networks. A DTN node generates a unique identifier (UID) and concatenates a static identifier part with the UID to form an endpoint identifier (EID).

### TECHNICAL FIELD

The present disclosure relates to the field of data networks. More specifically, the present disclosure relates to a method for configuring a delay/disruption-tolerant network node, and to a configurable node operable in a delay/disruption-tolerant network.

### BACKGROUND

Delay/disruption-Tolerant Networks (DTN) are capable of operating in highly stressed environments, under conditions of intermittent connectivity, long delays, variable delays and/or high transmission error rates. An example of application of DTN relates to the use of man-made nodes present in deep space, such as satellites, probes and rovers, travelling at great distances from earth within the Solar System. Request For Comments (RFC) 4838 published by the Internet Engineering Task Force (IETF), describes a “Delay-Tolerant Networking Architecture”. RFC 4838 generally describes how problems stemming from use of the traditional Transaction Control Protocol/Internet Protocol (TCP/IP) suite are overcome using a message-oriented overlay on top of TCP/IP.

DTN nodes are identified by use of Endpoint IDentifiers (EID), each DTN node having its own EID and having a routing table of EIDs assigned to neighboring nodes. A specific EID is manually assigned to each DTN node. Because a given DTN node needs to be known by routing tables of its neighboring nodes, adding a new DTN node to a network or modifying an existing DTN node involves a reconfiguration of a plurality of nodes. While some DTN nodes may be present on the ground and may be easily reconfigured, ground-based DTN nodes may be in communication with neighboring DTN nodes present in deep space. Reconfiguration of distant DTN nodes poses evident challenges.

Therefore, there is a need for improved methods and nodes for configuring DTN nodes.

### BRIEF DESCRIPTION OF THE DRAWINGS

Embodiments of the disclosure will be described by way of example only with reference to the accompanying drawings, in which:

FIG. 1 is a schematic representation of a contact header format;

FIG. 2 is a schematic representation of a protocol stack used in delay/disruption-tolerant networks;

FIG. 3 is a schematic representation of an endpoint identity according to an embodiment;

FIG. 4 is a sequence diagram of a method for creating and sharing endpoint identities according to an embodiment; and

FIG. 5 is a block diagram of a delay/disruption-tolerant network node according to an embodiment.

### DETAILED DESCRIPTION

The foregoing and other features will become more apparent upon reading of the following non-restrictive description of illustrative embodiments thereof, given by way of example only with reference to the accompanying drawings.

Various aspects of the present disclosure generally address one or more of the problems of reconfiguring Delay/disruption-Tolerant Network nodes. The present disclosure introduces a method for configuring a DTN node. The method involves generation of a unique identifier part of an endpoint identity. The endpoint identifier is obtained by concatenation of a static identifier part of the endpoint identity with the unique identifier part. A corresponding node is also introduced.

The following terminology is used throughout the present disclosure:
Delay/disruption-Tolerant Network (DTN): a network capable of operating in a highly stressed environment, under conditions of intermittent connectivity, long delays, variable delays and/or high transmission error rates.
DTN node: a node made part of a Delay/disruption-tolerant network.
Endpoint IDentifier (EID): an identity of a node topologically located at an endpoint of a network.
Dynamic EID: an EID that is not necessarily defined by manual configuration and that does not necessarily have a permanent or semi-permanent value.
Static identifier part: a predetermined part of an identifier.
Scheme name: part of an EID that designates a type of node.
Scheme-Specific Part (SSP): part of an EID that is specific to a given node.
Unique IDentifier (UID): an identifier that is guaranteed to be unique within a certain domain.
Universally Unique IDentifier (UUID): an identifier that is unique on a scale of the DTN deployment, world and space networks, with a very high probability.
Concatenation: juxtaposition of two or more elements or data fields.
Peer node: in relation to a given node, another node with which the given node may be in communication; the given node and the peer node may be similar nodes or may be entirely dissimilar.
Bundle: a protocol data unit in DTN; a bundle usually carries payload data.
Transaction control protocol convergence layer (TCPCL): a layer in a DTN protocol stack that uses an underlying transport mechanism to send and receive bundles.
Contact header: a packet of information exchanged between a node and a peer node following initial set-up of a TCPCL connection.
Routing table: a table of identities used by a node to route bundles through a network towards other nodes.
Memory: a temporary or a non-volatile memory implemented as one or more data storage elements.
Processor: a node component, or a combination of node components, capable of executing processing tasks.
Communication port: a node component, or a combination of node components for sending and receiving signals and bundles.
Self Describing Numeric Value (SDNV): a variable length encoding for integer values that makes a full inventory of the number of digits of each kind it contains.

Those of ordinary skill in the art will readily appreciate that communication between nodes, or endpoints, may rely on support from various types of networks comprising various types of communication links and intermediate nodes. Consequently, in the context of the present disclosure, communication between various nodes may be made via other nodes that are not necessarily shown on the drawings. It should thus be understood that expressions such as “sending to” or “receiving from” do not imply that a sending node and a receiving node are connected via a direct physical link.

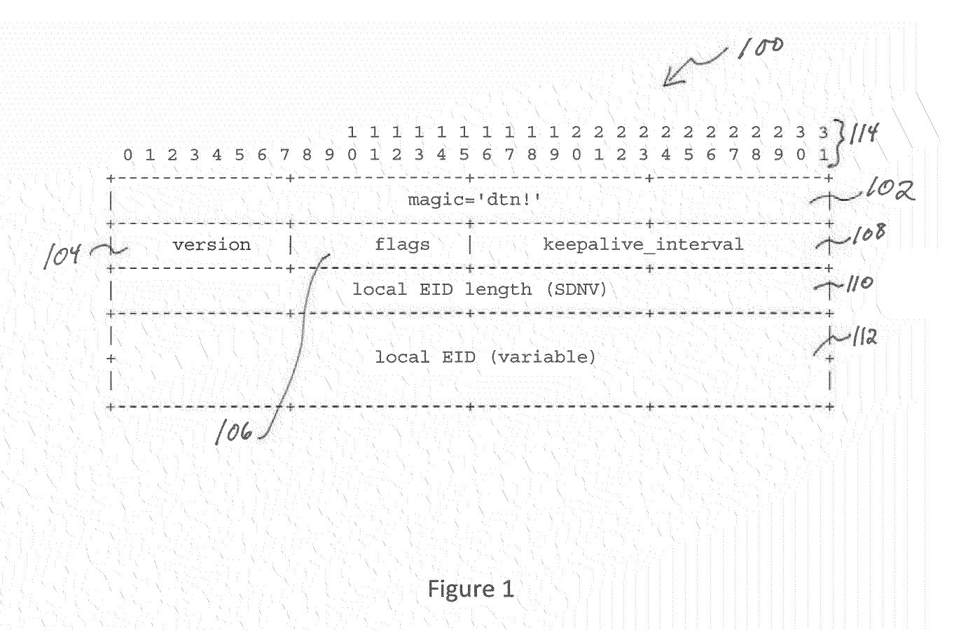

Referring now to the drawings, FIG. 1 is a schematic representation of a contact header format. As will be explained hereinbelow, a DTN node may exchange EID information with a peer node by sending and receiving EID values encapsulated within a contact header. Fields of a contact header 100 comprise:
Magic (102): A four byte field containing a byte sequence for the text string “dtn!”.
Version (104): A one byte field value containing the current version of the protocol.
Flags (106): A one byte field containing optional connection flags.
Keepalive_interval (108): A two byte integer field containing the number of seconds between exchanges of keepalive messages on a connection in network byte order.
Local EID length (110): A variable length Self Describing Numeric Value (SDNV) field containing a length of an endpoint identifier for some singleton endpoint in which the sending node is a member; a four byte SDNV is depicted for clarity of the Figure, without limiting the present disclosure.
Local EID (112): An octet string containing an EID of a singleton endpoint in which a sending node is a member, in a canonical format of <scheme name>:<scheme-specific part>; an eight byte EID is shown the clarity of the Figure, without limiting the present disclosure.

On FIG. 1, indicia 114 represent a bit count of the fields 102-112.

It should be understood that the contact header 100 as shown on FIG. 1 is an example specific to a particular embodiment and that persons of ordinary skill in the art will be capable of developing other contact header formats.

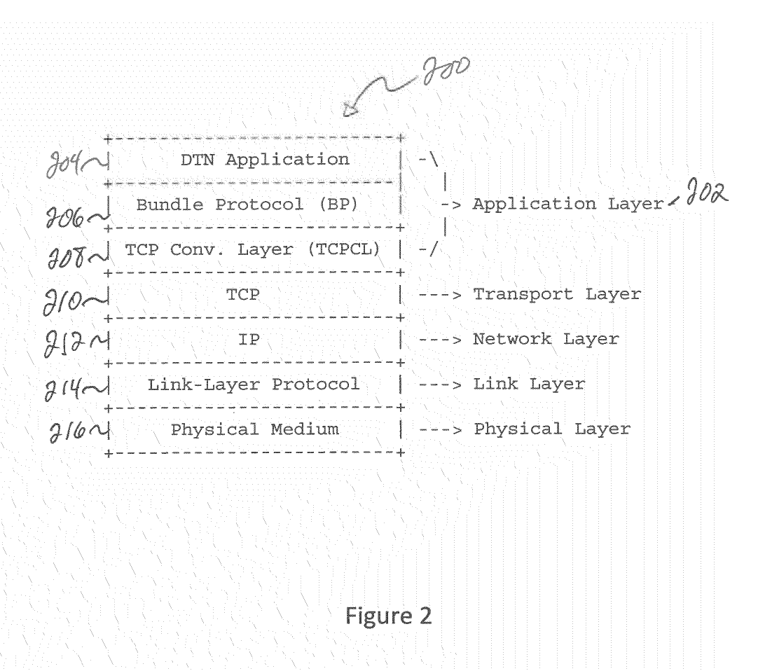

FIG. 2 is a schematic representation of a protocol stack used in delay/disruption-tolerant networks. A protocol stack 200 used by communicating DTN nodes comprises the following elements:
An application layer 202 further split into a DTN application layer 204 at the top, a Bundle Protocol (BP) layer 206 and a TCP Convergence Layer (TCPCL) layer 208 at the bottom of the application layer 202.
A Transaction Control Protocol (TCP) layer 210 as a Transport Layer.
An Internet Protocol (IP) layer 212 as a Network Layer.
A Link-Layer Protocol (214) as a Link Layer, also known as a Layer 2.
A Physical Medium (216) as a Physical Layer.

The four (4) lower layers 210-216 of the protocol stack 200 form an IP protocol stack and may comprise an IP version 4 (IPv4) protocol suite or an IP version 6 (IPv6) protocol suite, as are well-known to those of ordinary skill in the art. These layers 210-216 may be replaced by other protocol layers without departing from the scope of the present disclosure. The convergence layer 208 may be consequently replaced by another convergence layer without departing from the scope of the present disclosure.

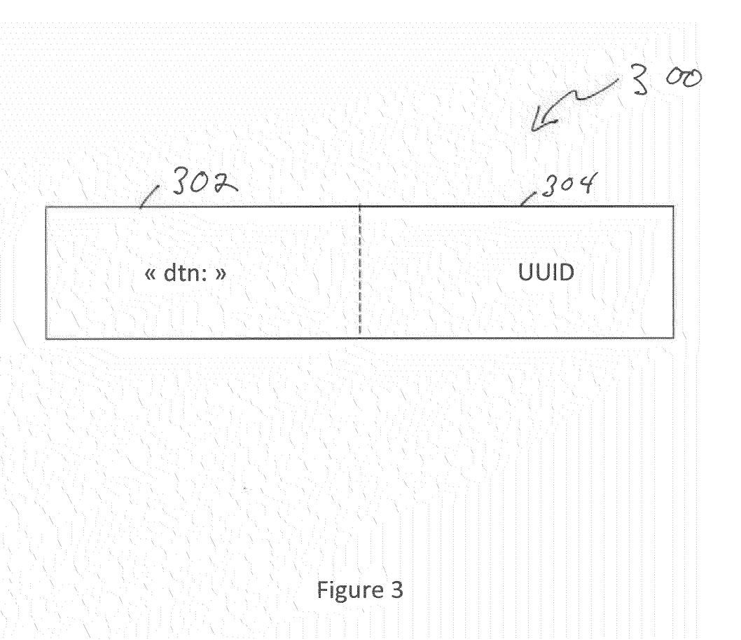

FIG. 3 is a schematic representation of an endpoint identity according to an embodiment. An example of Endpoint IDentifier (EID) 300 comprises two (2) concatenated fields. A first field may be a static identifier part 302 consisting, in an embodiment, of a scheme name designating the DTN node as a DTN-type node. A second field may be a unique identifier (UID) 304, which may, in some embodiments, be a scheme-specific part (SSP). In a particular embodiment, the UID 304 may consist of a Universally Unique IDentifier (UUID).

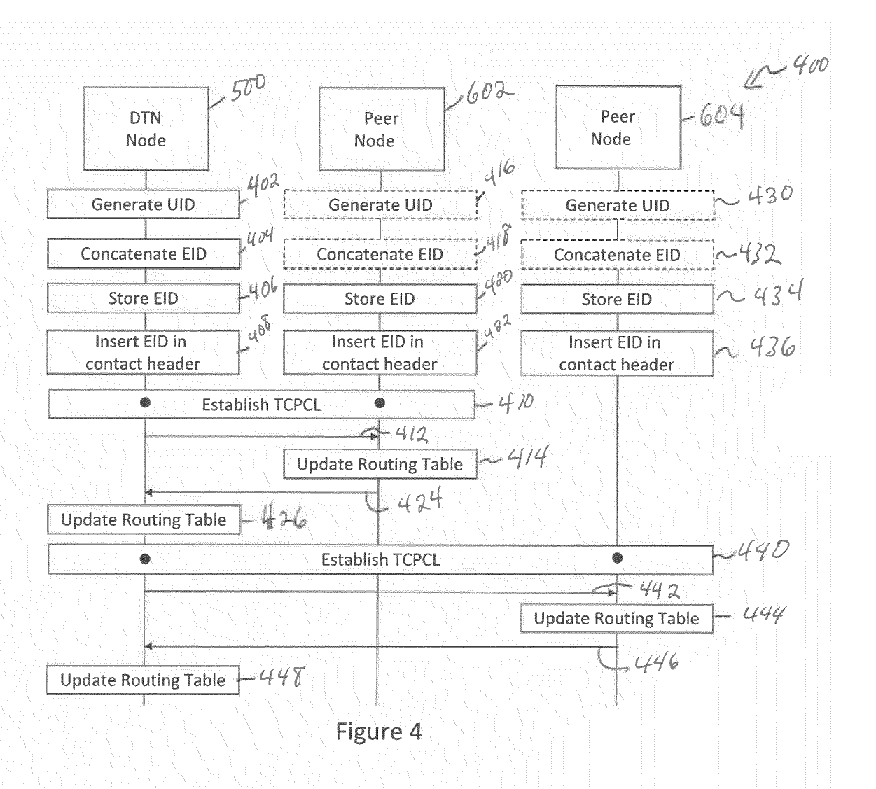

FIG. 4 is a sequence diagram of a method for creating and sharing endpoint identities according to an embodiment. Steps of the method are shown as a sequence 400. Some of the steps are optional and may therefore be present, or not, in various embodiments. Steps of the sequence 400 are not necessarily executed in the order as shown. The sequence 400 shows events occurring in a DTN node 500 and between the DTN node 500 and two Peer Nodes 602 and 604. The DTN node 500 may communicate with other DTN nodes or with other nodes comprising less than a full set of DTN features. Consequently, the Peer Nodes 602 and 604 may or may not be other DTN nodes. The DTN node 500 performs a self-configuration of an EID by first generating a unique identifier (UID) at step 402 and by then concatenating a static identifier part with the UID to form the EID at step 404. The DTN node 500 may store the EID in a memory at step 406. In order to propagate its EID towards Peer Nodes, the DTN Node 500 inserts its EID in a contact header at step 408. Then, at step 410, a transaction control protocol convergence layer (TCPCL) connection is established with the Peer Node 602. Establishment of the TCPCL connection may be initiated either by the DTN Node 500 or by the Peer Node 602. The DTN node 500 then forwards the contact header towards the Peer Node 602 at step 412. The Peer Node 602 may update its routing table with the EID of the DTN Node 500 at step 414.

The Peer Node 602 may also generate its own EID, for example by generating its own UID at step 416 and by concatenating a static identifier part with its own UID to form its own EID at step 418. The Peer Node 602 may then store its own EID into a memory at step 420. Alternatively, the Peer Node 602 may have a manually configured EID, stored in a memory at step 420.

The Peer Node 602 may also update the DTN Node 500 with its own EID. For this, the Peer Node 602 may insert its own EID into a contact header at step 422 and forward that contact header towards the DTN Node 500 at step 424.

It should be understood that step 424 does not necessarily follow any of steps 402-414 since EIDs may be independently generated in the DTN Node 500 and in the Peer Node 602, or independently assigned in the Peer Node 602. Likewise, decisions taken in the DTN Node 500 and in the Peer Node 602 to propagate their respective EIDs are independent and may occur at any time following generation or assignment of their respective EIDs. Consequently, the order of steps shown on FIG. 4 represents a particular embodiment.

Having received the contact header from the Peer Node 602 at step 424, the DTN Node 500 updates its routing table with the EID of the Peer Node 602 at step 426.

The other Peer Node 604 may also generate its own EID, for example by generating its own UID at step 430 and by concatenating a static identifier part with its own UID to form its own EID at step 432. The Peer Node 604 may then store its own EID into a memory at step 434. Alternatively, the Peer Node 604 may have a manually configured EID, stored in a memory at step 434. The Peer Node 604 may then insert its own EID into a contact header at step 436.

A TCPCL connection may be established between the DTN Node 500 and the Peer Node 604 at step 440, the connection being initiated either by the DTN Node 500 or by the Peer Node 604. The DTN Node 500 may then forward a contact header towards the Peer Node 604 at step 442, either carrying the EID of the DTN Node 500 or carrying the EID of the Peer Node 602. Of course, the DTN Node 500 may forward both EIDs in the same step 442 or in distinct steps. The Peer Node 604 updates its routing table with the received EID or EIDs at step 444 and may then forward its own EID to the DTN Node 500 at step 446. The DTN Node 500 may then update its routing table with the EID of the Peer Node 604 at step 448.

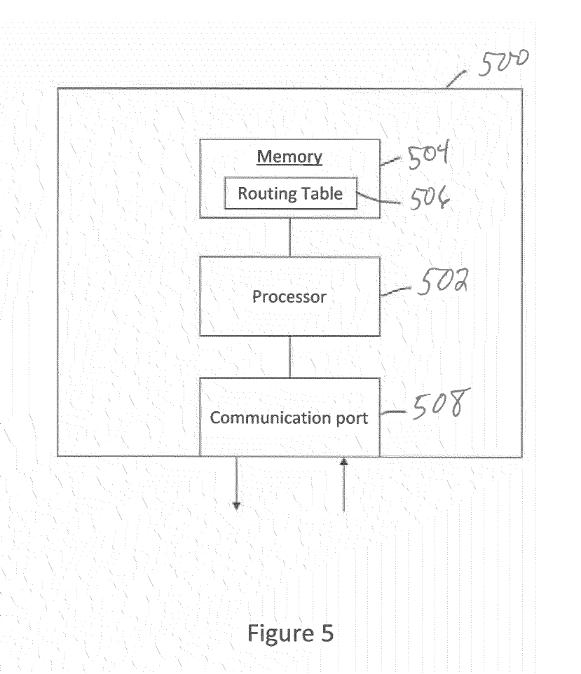

FIG. 5 is a block diagram of a delay/disruption-tolerant network node according to an embodiment. The DTN node 500 introduced in the foregoing description of FIG. 4 comprises a processor 502 and may further comprise a memory 504, and a communication port 508 for sending bundles towards peer nodes and for receiving bundles from peer nodes. The memory 504 may further comprise a routing table 506. The processor 502 is capable of generating a unique identifier (UID). The processor may then concatenate a static identifier part with the UID to form an endpoint identifier (EID) of the DTN node 500, for example in compliance with the format of the EID 300 introduced in the foregoing description of FIG. 3. The processor 502 may store the EID in the memory 504. The processor 502 is also capable of inserting the EID of the DTN node 500 in a bundle and of instructing the communication port 508 to forward the bundle towards a peer node.

An EID of a peer node may be received at the communication port 508, for example as a part of a bundle. The communication port 508 may then forward the EID of the peer node to the processor 502, which in turn may store the EID of the peer node in the routing table 506.

The DTN node 500 may further comprise other elements (not shown) in support of DTN applications conferred thereto. The processor 502 may be capable of generating a UUID. The processor 502 may also be capable of forming or decoding contact headers 100 according to the format described in the foregoing description of FIG. 1, and may support the protocol stack 200 introduced in the foregoing description of FIG. 2 as well as other protocol stacks. As shown on FIG. 4, the DTN node 500 may also establish TCPCL connections with its peer nodes, and may forward to a second peer node an EID receiving from a first peer node.

Those of ordinary skill in the art will realize that the description of the nodes and methods for configuring DTN nodes are illustrative only and are not intended to be in any way limiting. Other embodiments will readily suggest themselves to such persons with ordinary skill in the art having the benefit of the present disclosure. Furthermore, the disclosed methods and nodes may be customized to offer valuable solutions to existing needs and problems of configuring DTN nodes.

In the interest of clarity, not all of the routine features of the implementations of the methods and nodes for configuring DTN nodes are shown and described. It will, of course, be appreciated that in the development of any such actual implementation of the methods and nodes, numerous implementation-specific decisions may need to be made in order to achieve the developer's specific goals, such as compliance with application-, system-, network- and business-related constraints, and that these specific goals will vary from one implementation to another and from one developer to another. Moreover, it will be appreciated that a development effort might be complex and time-consuming, but would nevertheless be a routine undertaking of engineering for those of ordinary skill in the field of DTN having the benefit of the present disclosure.

In accordance with the present disclosure, the components, process steps, and/or data structures described herein may be implemented using various types of operating systems, computing platforms, network devices, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used. Where a method comprising a series of process steps is implemented by a computer or a machine and those process steps may be stored as a series of instructions readable by the machine, they may be stored on a tangible medium.

Systems and modules described herein may comprise software, firmware, hardware, or any combination(s) of software, firmware, or hardware suitable for the purposes described herein. Software and other modules may reside on servers, workstations, personal computers, computerized tablets, personal digital assistants (PDA), and other devices suitable for the purposes described herein. Software and other modules may be accessible via local memory, via a network, via a browser or other application or via other means suitable for the purposes described herein. Data structures described herein may comprise computer files, variables, programming arrays, programming structures, or any electronic information storage schemes or methods, or any combinations thereof, suitable for the purposes described herein.

Although the present disclosure has been described hereinabove by way of non-restrictive, illustrative embodiments thereof, these embodiments may be modified at will within the scope of the appended claims without departing from the spirit and nature of the present disclosure.

What is claimed is:

1. A method for configuring a delay/disruption-tolerant network (DTN) node, comprising:
generating a unique identifier (UID); and
concatenating a static identifier part with the UID to form an endpoint identifier (EID).

2. The method of claim 1, wherein:
the static identifier part is a scheme name designating the DTN node as a DTN-type node.

3. The method of claim 2, wherein:
the UID is a scheme-specific part (SSP).

4. The method of claim 1, wherein:
the UID is a universally unique identifier (UUID).

5. The method of claim 1, comprising:
inserting the EID in a contact header; and
forwarding the contact header towards a peer node.

6. The method of claim 5, comprising:
establishing a transaction control protocol convergence layer (TCPCL) connection with the peer node before forwarding the contact header.

7. The method of claim 1, comprising:
receiving a first contact header from a first peer node, the first contact header comprising an EID of the first peer node; and
updating a routing table of the DTN node with the EID of the first peer node.

8. The method of claim 7, comprising:
forwarding the first contact header towards a second peer node.

9. The method of claim 7, comprising:
receiving a second contact header from a second peer node, the second contact header comprising an EID of the second peer node; and
updating a routing table of the DTN node with the EID of the second peer node.

10. The method of claim 1, wherein:
storing the EID in a memory.

11. A node in a delay/disruption-tolerant network (DTN), comprising:
a processor for:
generating a unique identifier (UID), and
concatenating a static identifier part with the UID to form an endpoint identifier (EID) of the node.

12. The node of claim 11, comprising:
a memory for storing the EID.

13. The node of claim 11, comprising:
a communication port for sending and receiving bundles.

14. The node of claim 13, wherein:
the processor is further capable of:
inserting the EID of the node in a bundle, and
instructing the communication port to forward the bundle towards a peer node.

15. The node of claim 13, comprising:
a routing table for storing an EID of a peer node received at the communication port.
